(19) United States
(12) Patent Application Publication
(10) Pub. No.: US 2023/0034251 A1
(43) Pub. Date: Feb. 2, 2023

(54) PAINTING BRUSH GRIP

(71) Applicant: BRIAN WENNINGER, Slinger, WI (US)

(72) Inventor: BRIAN WENNINGER, Slinger, WI (US)

(73) Assignee: Top Branch 3D, LLC, Slinger, WI (US)

(21) Appl. No.: 17/873,328

(22) Filed: Jul. 26, 2022

Related U.S. Application Data
(60) Provisional application No. 63/226,568, filed on Jul. 28, 2021.

(51) Int. Cl. A46B 5/02; A46B 17/02; B25G 1/10

(52) U.S. Cl. CPC A46B 5/02; A46B 17/02; B25G 1/102; A46B 2200/202

(57) ABSTRACT

A grip for a paint brush. The grip has an increased coefficient of force between the user and the grip compared to the user and the paintbrush. The grip provides a cover for the paint brush during the painting process to minimize discomfort for the user and also allows for the collection of paint or other fluids when painting to reduce mess for the user and the user's hand.

### RELATED APPLICATIONS

This application claims the benefit of co-pending U.S. provisional application Ser. No. 63/226,568, filed on 28 Jul. 2021.

### BACKGROUND OF THE INVENTION

The present invention is related to grips for paint brushes and devices for increasing the grip potential between a painter's hand and a paint brush.

For decades the paint brush design has typically remained unchanged. The brush consists of three sections. The handle is typically wooden, but sometimes made of plastic. There are bristles for holding and applying fluid-like substances, ranging from: household paint, stain, varnishes, and other glue-like substances. Some people may even use them to brush butter and sauces onto food. The bristles are held in place via glue and then wrapped by a metal ferrule which is joined to the handle. The brush handle has sharp corners, and the metal edge of the ferrule is generally sharp (see FIG. 1). These sharp edges can cause calluses, cuts, abrasions, pain, and/or discomfort to the brush user.

Consequently, a user may need to exert extra force on the brush so that the user maintains the feeling of the brush, which has the potential to cause discomfort over time and the potential formation of callouses on the user's hand (see FIG. 1).

Painters commonly wrap a brush handle with a rag or cloth to hold paint as it runs on to the ferrule and reduce some of the friction between the painter's hand and the brush. However, this is generally inefficient. Likewise, gloves are cumbersome and not preferred by many painters who prefer the natural feel of using tools with their bare hands.

Brush users may also experience hand and finger muscle cramps. The metal and wood surfaces of a brush are smooth, which may be easy to clean, but require the user to apply a higher amount of force to increase static friction and maintain a good hold of the brush during operation.

### SUMMARY OF THE INVENTION

The present invention addresses the above issues by providing a grip and covering for a paint brush. The grip is shaped to conform to the contours of a brush handle. The grip generally comprises a main body portion and a handle portion. The grip covers up the sharp corners and edges of the brush handle and ferrule. The grip also comprises a flange located on the main body portion, which provides an area for slowing and/or holding the paint as it runs along the bristles onto the ferrule and the user's fingers.

The grip of the present invention may also comprise a removable insert that will further aid in stopping paint and/or stain from running onto the handle of the brush and onto the fingers of the user.

The grip may be made of a solid washable material and may be manufactured from a mold or a 3-D printer. The grip may be removable and reusable between different brushes.

The grip of the present invention provides a surface with an increased coefficient of friction between a user's hand and the invention compared to the user's hand and the paint brush, thereby allowing the user to apply a smaller amount of gripping strength to hold and control the paint brush. This allows the user to apply less gripping force, therefore diminishing potential for muscle cramps.

### BRIEF DESCRIPTION OF THE DRAWINGS

FIG. 1 depicts a typical paint brush and a painter's finger depicting a callus on the finger from gripping the paint brush.

FIG. 2 is a perspective view of a paint brush grip according to the present invention.

FIG. 3A is an exploded view of the grip of FIG. 2 with a paintbrush.

FIG. 3B shows the grip positioned on a paintbrush.

FIG. 4 is a front view of the grip of FIG. 2.

FIG. 5 is a side-view of the grip of FIG. 2.

FIG. 6 is a cross-sectional view of the grip of FIG. 2 taken along the line 6-6 of FIG. 4.

FIG. 7 shows the grip in use.

FIG. 8 shows a perspective view of an alternate embodiment of a grip according to the present invention.

FIG. 9 is a front perspective view of the grip of FIG. 8.

FIG. 10 is a cross-sectional view of the grip of FIG. 8 taken along line 10-10 of FIG. 9.

FIG. 11 demonstrates an insert being removed from the grip.

FIG. 12 is a perspective view of a further embodiment of the present invention.

FIG. 13 is a front view of the grip shown in FIG. 12.

FIG. 14 provides diagram of a coefficient of static friction ramp slide test and calculation.

FIG. 15 demonstrates an alternate arrangement of the indents shown and demonstrated in FIG. 2.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

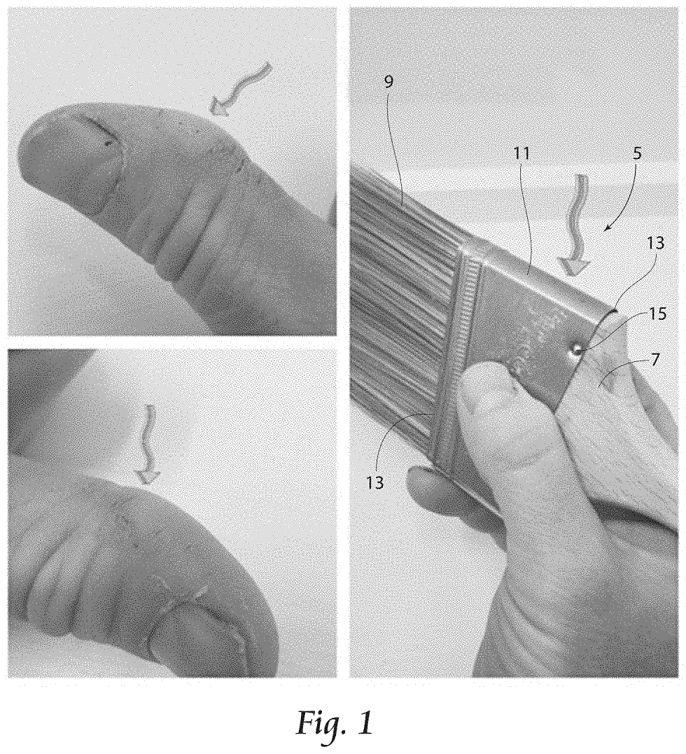

As discussed above (Background of the invention), FIG. 1 depicts a typical paint brush 5, made up of a handle 7, bristles 9, and a ferrule 11 securing the bristles 9 to the handle 7. The sharp edges and corner 13 of the ferrule, as well as the sharp indents 15 in the ferrule 11 edges can cause cuts, abrasions, pain, and/or discomfort to the brush user. Particularly, the pressure exerted by the user on the brush 5 and ferrule 11 can cause calluses on the user's hand (shown with arrows).

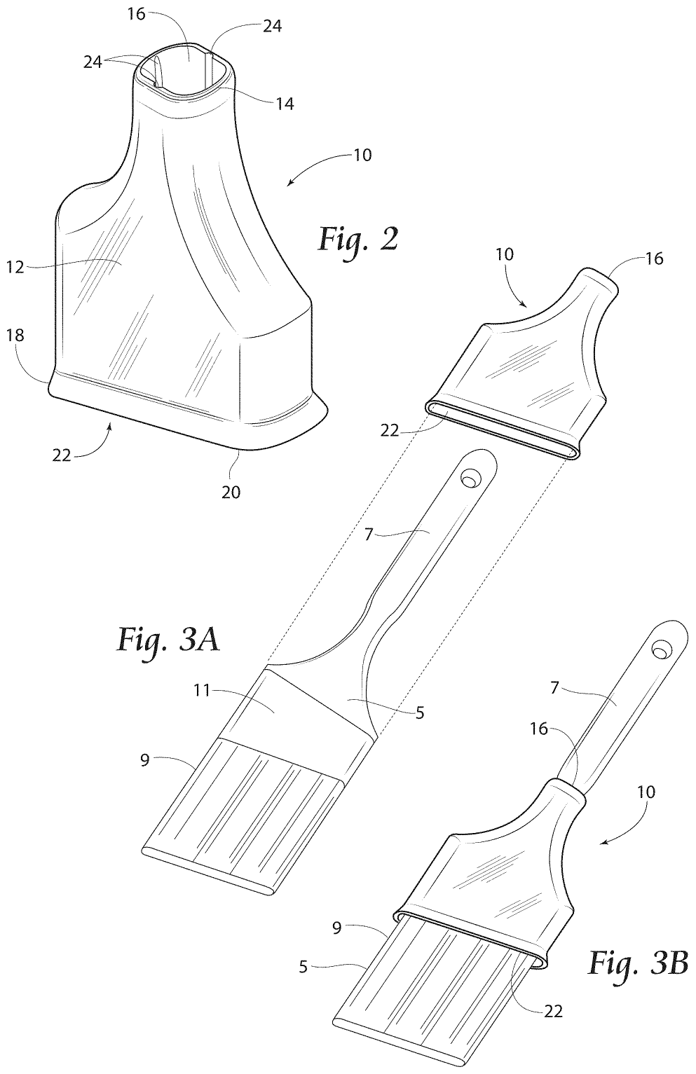

FIG. 2 is a perspective view of a paint brush grip 10 according to the present invention. The grip 10 is designed to fit over a paintbrush 5 (see FIG. 3B). The grip 10 generally comprises a body 12 having a top end 14 forming an opening 16. The body 12 extends from the top end 14 to a bottom end 18. The bottom end 18 has an outwardly extending flange 20 that will be discussed in further detail, below. The flange 20 forms a second opening 22.

FIGS. 3A and 3B depict the grip 10 being put on the paintbrush 5. The openings 16 and 22 are sized and configured to tightly and securely fit around the respective portions of the brush, the handle 7 and the bristles 9. That is, the opening 16 is sized to securely fit around the handle 7, and the opening 22 is sized and configured to fit around the bristles 9. It should be understood that the present invention is designed so that the dimensions of the openings 16 and 22 and the body 12, in general, will be formed for brushes of varying sizes and particularly shaped and formed to fit standard paint brushes used in painting walls and similar surfaces.

Referring again to FIG. 2, the opening 16 further comprises indents 24, which assist the user in placing the grip over the brush 5 (FIG. 3B). The indents 24 minimize the force required between the grip 10 and the brush when the user is fitting the grip 10 on the brush, while maintaining the tight fit of the grip 10 on the brush.

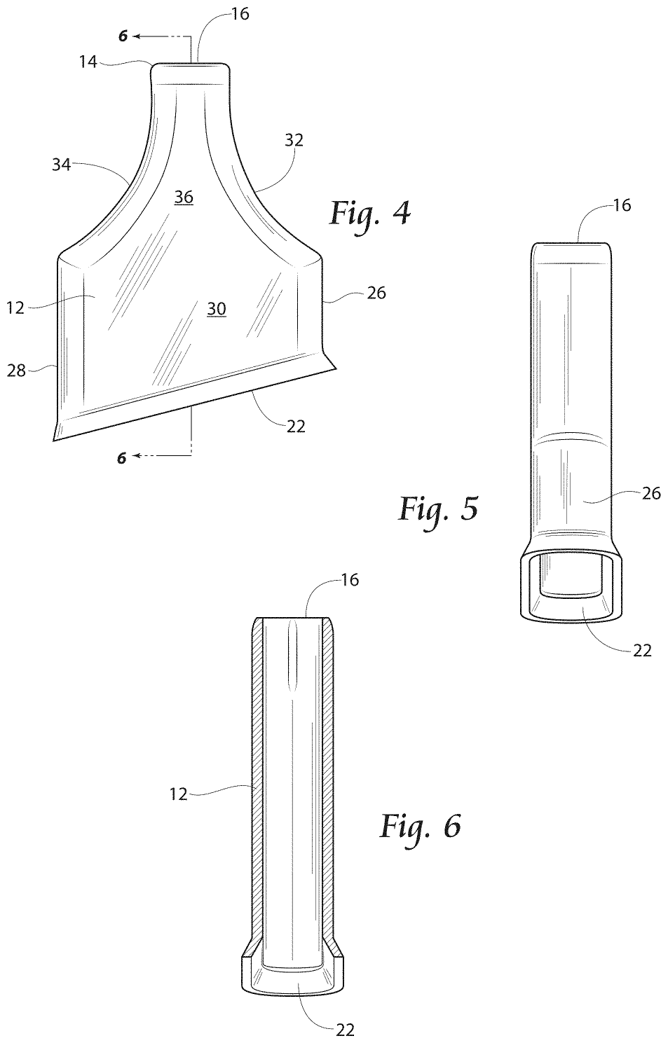

FIG. 4 provides a front view of the grip 10. The grip 10 has a first side 26 and a second side 28, with the first side 26 being shorter than the second side. As such, the opening 22 is angled with respect to the opening 16, shaped and designed to be of the same dimensions of a typical paintbrush. The angle is further demonstrated in FIG. 5, where the grip 10 is viewed from the first side 26, whereby the inside of the second side 28 can be seen. Once the grip 10 is positioned on the paint brush 5, the opening 22 will fit evenly over the brush, parallel with the bristles 9 (see FIG. 3B).

Referring further to FIG. 4, the sides 26 and 28 and the opening 22 generally form a body portion 30 of the grip 10, with the body portion 30 is sized to securely fit on bristles 9 and the ferrule 11 of the paint brush 5 (FIG. 3A). The sides 26 and 28 each are connected to a respective curved upper section 32 and 34, thereby forming a handle portion 36 of the grip 10. The handle portion 36, as demonstrated in FIG. 3B, is designed to fit only over a portion of the handle 7 and not the entire length of the handle 7. The arrangement allows the grip 10 to be easily fitted on the brush, without needing undo pressure and exertion to fit the handle portion 36 over the entire length of the handle 7.

FIG. 6 provides a cross-sectional view of the grip 10, depicting an indent 24. The indent extends partially along the top of upper section 34 providing assistance and allowing for flexibility when fitting the grip 10 on the brush 5, as discussed above. The length of the indent 24 is generally consistent with the length of the handle portion 36 that is in contact with the handle 7 of the brush 5.

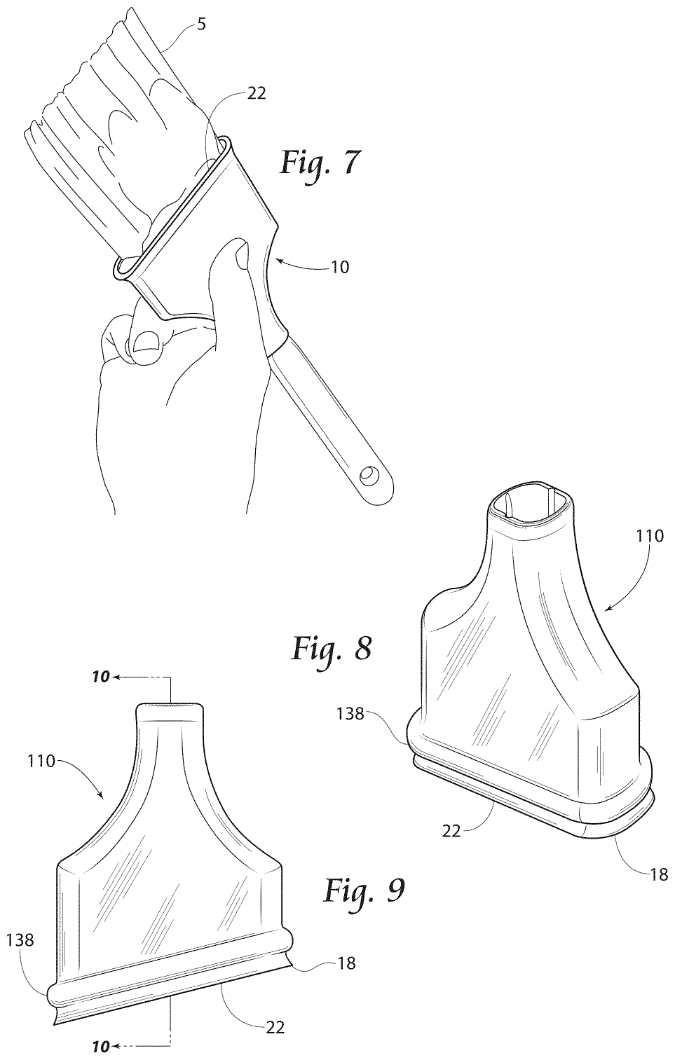

Referring now to FIG. 7, the grip 10 is shown in use on the brush 5. When painting, particularly above one's head, paint will run or slide down the brush 5 towards the handle 7. Prior to the present invention, this would result in an unnecessarily messy handle and/or hand of the user. However, the flange 20 flares out from the bottom end 18, thereby catching the paint and addressing the problems of the prior art. The flange 20 essentially acts like a dam reservoir. Likewise, because the body portion 30 is designed to fittingly engage the brush 5, the paint will collect within the flange 22, but will not extend further down the brush 5 and the brush handle 7. This keeps the user's hands clean while maintaining a dry contact surface for ample friction and increased grip potential for maximum control of the brush 5.

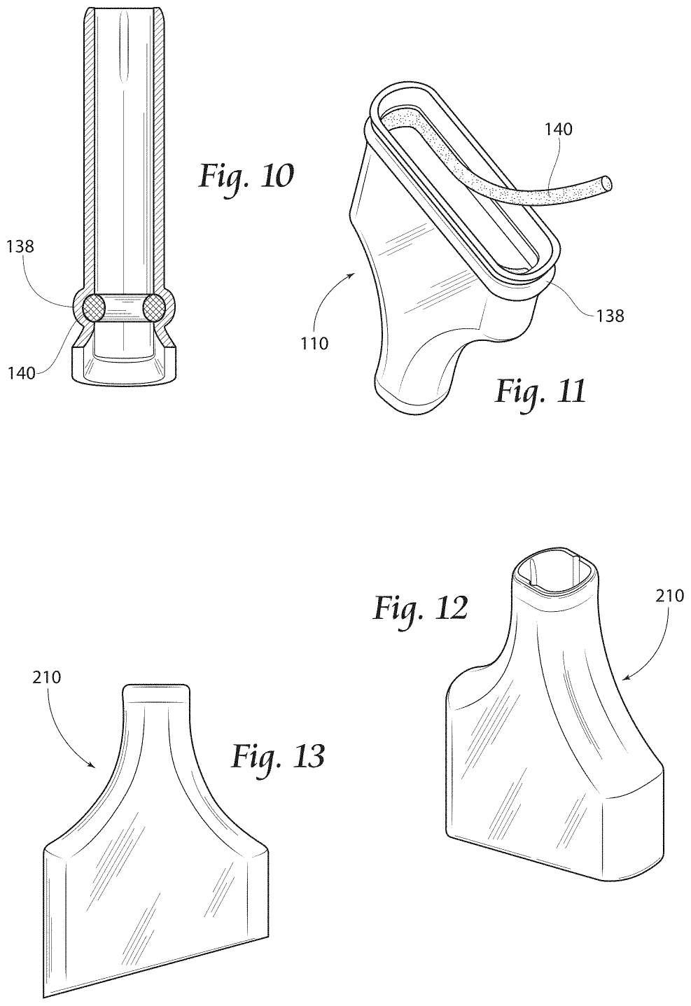

FIGS. 8-10 provide for an alternate embodiment of the present invention. The grip 110 is designed similar to the grip 10, but an additional channel 138 is located near the end 18 and above the flange 22. As shown in FIG. 10, the channel 138 houses a flexible, removable insert 140. The insert 140 provides further protection for the user and for preventing paint to run down the handle of the brush. The insert 140 is preferably made of a flexible material such as rope or foam, which can be removed (see FIG. 11) from the grip 110 and replaced, if necessary. The insert 140 is preferably designed of an absorbent material and may be disposable, as well. The channel 138 and insert 140 also helps keep the exterior surface of the brush grip clean, along with the user's hands, especially during overhead vertical use.

As is appreciated from the above discussion, the present invention is designed to minimize the mess associated with running of paint when painting, while also minimizing the force required between the user's hand and the brush 5 for a proper grip. Because the grips of the present invention are designed to fittingly and snugly engage the paint brush, the functions of the present invention can be accomplished with minimal extra design required. For example the grip 210 shown in FIGS. 12 and 13 provide for an efficient design to catch paint overflow and to minimize force between the user and the brush 5, without a flange 22, similarly as shown with grips 10 and 110. Likewise, the design shown in FIGS. 12 and 13 will still increase the coefficient of static friction between the user and invention, as discussed above.

FIG. 15 further demonstrates the ability of the present invention to be used for brushes of varying size. The grip 10 is shown, but with an alternate version of indents 124. The indents 124 extend entirely through the upper section 32 and 34, essentially designed as a slit, in contrast to the previous indents 24 that were situated on the internal sides of the upper sections 32 and 34 (see FIG. 2). The indents 124 are designed to allow the grip 10 to be situated on the brush 5 as previously discussed, but will accommodate brushes with a larger handle or a handle that does not have a uniform thickness or diameter over the entire length of the handle. The indents 124 will be able to spread out over the handle. To help insure the integrity of the grip 10 and mitigate and diminish the potential for the indents 124 and the grip 5 to tear, circular relief cut outs 125 are located at the end of the indents 124.

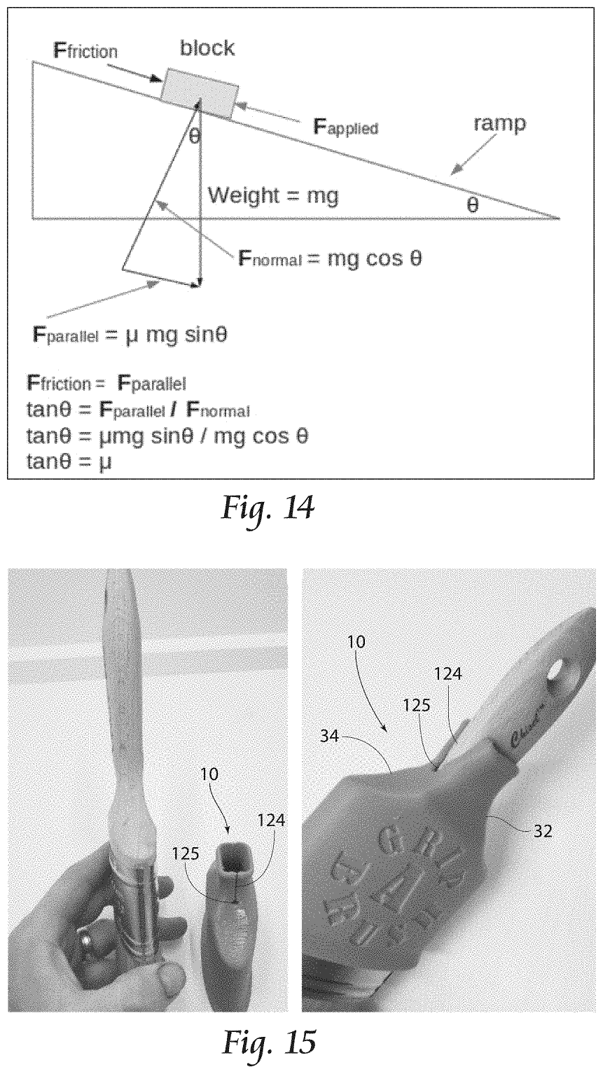

The grips of the present invention are preferably designed from a sturdy, flexible plastic material for minimizing the force required between the user's hand and the brush 5 for a proper grip of the brush. The grips may be formed using a 3-D printer or from a mold to insure proper shape so that the grip properly fits on a brush handle. The material may be any sufficient plastic, e.g. a polymer or elastomer that can provide sufficient support and flexibility for the grip, while maintaining the sufficient rigidity to supply the above qualities. Non-limiting examples include thermoplastic elastomers (TPE), preferably a thermoplastic polyurethane (TPU). As discussed above, the present invention reduces the pressure applied between the user and the brush 5, even while increasing the coefficient of static friction of the user and the invention compared to the user and a brush, in general. The coefficient of static friction can be measured though a ramp slide test, as shown in FIG. 14. An increase in the force applied (F normal), will increase the coefficient of friction. This is why a brush user must apply a higher level of force to hold a brush when the surface is smooth, slick, slippery, or wet. It is generally known that some materials have a higher level of friction, such as rubber. Therefore, a rubber surface in contact with human skin should have a higher coefficient of friction than a metal surface in contact with human skin. Thus, the present invention allows the user to apply less force to maintain a good hold and grasp of the brush, potentially reducing muscle fatigue and cramps, as well. Such increases in the coefficient of friction and reductions in applied force can also be beneficial in mitigating issues such as Carpal Tunnel syndrome for painters.

A further advantage of the present invention and the materials used is the comfort associated with the grip, particularly when using in cold temperatures. The metal ferrule on a paint brush is very cold to touch and hold by a user in cold temperatures. The Thermal Conductivity rate of stainless steel is 14.4 watts/meter-Kelvin (W/mK) (K-value). (Stainless, n.d.). In comparison many rubber-like materials have a very low rate with a range of 0.045 to 0.13 W/mK (Rubber, n.d.). Essentially this is why metal feels cold to touch, because it draws energy easily from the user's contact skin. Meanwhile, rubber is known to be a resistor, and resists the transfer of energy. As a result, the present invention allows for the painter to paint for longer periods of time without having to worry about discomfort when painting in such temperatures and conditions.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

I claim:

1. A grip for a paint brush having a handle and bristles, said grip comprising:
a body, having a top end and a bottom end;
an opening located in said top end of said body configured to fit around said handle;
an opening located in said bottom end of said body configured to fit around said bristles; and
a flange extending outwardly from said bottom end of said body.

2. The grip according to claim 1 further comprising:
at least one indent located in said top opening.

3. The grip according to claim 2 comprising two or more of said indents.

4. The grip according to claim 1 further comprising a channel located within said body.

5. The grip according to claim 4, wherein said channel is located adjacent said flange.

6. The grip according to claim 5, further comprises an insert located within said channel.

7. The grip according to claim 6, wherein said insert is removable.

8. The grip according to claim 6, wherein said insert is absorbable.

9. A grip for a paint brush having a handle and bristles, said grip comprising:
a body, having a top end and a bottom end;
an opening located in said top end of said body configured to fit around said handle;
at least one indent located within said top opening, said indent allowing said top end to adjust to the size of the handle;
an opening located in said bottom end of said body configured to fit around said bristles;
a flange extending outwardly from said bottom end of said body.

10. The grip according to claim 9, further comprising at least two indents.

11. The grip according to claim 10, wherein said indents extend through the said top end.

12. The grip according to claim 10 further comprising a channel located in said body.

13. The grip according to claim 10 wherein said channel is adjacent to said flange.

14. A grip for a paint brush for a painter, said paint brush having a handle and bristles, said grip comprising:
a body, having a top end and a bottom end, said body shaped to extend over a portion of said handle and a portion of said bristles;
an opening located in said top end of said body configured to fit around said handle;
an opening located in said bottom end of said body configured to fit around said bristles; and
a flange extending outwardly from said bottom end of said body, wherein said body is formed of a material that increases the coefficient of friction between said brush and said painter.

15. The grip according to claim 14 further comprising a channel located adjacent said flange

16. The grip according to claim 15 further comprising an insert located in said channel.

17. The grip according to claim 16 wherein said insert is removable.

18. The grip according to claim 17, wherein said insert is flexible.

19. The grip according to claim 17, wherein said insert is made of an absorbable material.

20. The grip according to claim 14 further comprising at least one indent located within said top opening, said indent allowing said top end to adjust to the size of the handle.
